(19) United States
(12) Patent Application Publication
(10) Pub. No.: US 2020/0197992 A1
(43) Pub. Date: Jun. 25, 2020

(54) FERRITE-BASED STAINLESS STEEL HAVING IMPROVED HEAT RADIATION PROPERTY AND PROCESSABILITY AND METHOD FOR PREPARING SAME

(71) Applicant: POSCO, Pohang-si, Gyeongsangbuk-do (KR)

(72) Inventors: Ji Eon Park, Pohang-si, Gyeongsangbuk-do (KR); Mi-Nam Park, Pohang-si, Gyeongsangbuk-do (KR)

(21) Appl. No.: 16/643,085

(22) PCT Filed: Dec. 11, 2017
(86) PCT No.: PCT/KR2017/014464

§ 371 Date: Feb. 28, 2020

(30) Foreign Application Priority Data
Aug. 31, 2017 (KR) 10-2017-0110818

(51) Int. Cl. B21B 3/02; B32B 15/01; C22C 38/28; C22C 38/26; C22C 38/00

(52) U.S. Cl. CPC B21B 3/02; B32B 15/012; C22C 38/001; C22C 38/26; C22C 38/28

(57) ABSTRACT

Provided are a ferrite-based stainless steel having improved heat radiation property and processability and method for preparing same. A ferritic stainless steel according to an embodiment of the disclosure, includes, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities, and the ferritic stainless steel is plated with aluminum (Al) having a thickness of 5 to 50 μm. Therefore, heat dissipation and workability of ferritic stainless steel may be improved by controlling ferritic stainless steel alloy composition, aluminum (Al) thickness and manufacturing method.

### TECHNICAL FIELD

The present invention relates to a ferritic stainless steel for battery cell case and a manufacturing method thereof, more specifically, the present invention relates to a ferritic stainless steel which can improve heat dissipation and workability by improving thermal conductivity through controlling component and Al plating, and a manufacturing method thereof.

### BACKGROUND ART

Among the stainless steels, especially ferritic stainless cold rolled product has excellent high temperature characteristics such as thermal expansion rate and thermal fatigue characteristics and are resistant to a stress corrosion cracking. Accordingly, ferritic stainless steel is widely used in vehicle exhaust system parts, household appliances, structures, home appliances, elevators, and the like.

Ferritic stainless steel has recently been applied in part for vehicle battery cells. To ensure long-term battery performance, vehicle manufacturers demand higher strength and corrosion resistance than conventional ferritic stainless steels, and also demand lower cost materials to lower battery prices.

In general, the lithium ion battery of an electric vehicle is a power supply component for each element of the vehicle and is repeatedly charged and discharged by the electric load and the generator of the vehicle.

The temperature rise of the battery during this process causes a change in the internal resistance of the battery, decreases the electrical performance, and brings about a problem in that the efficient electrical management of the vehicle cannot be achieved.

Therefore, the characteristic of discharging heat generated inside the battery cell to the outside is very important due to the characteristics of the battery having high output and high capacity.

Mainly, aluminum (Al) is used as a material for battery cell cases, because aluminum (Al) has a very high thermal conductivity and is excellent in terms of heat dissipation.

On the other hand, ferritic stainless steel has excellent corrosion resistance compared to aluminum (Al), but due to many alloying elements, heat dissipation is significantly reduced.

In addition, when processing a battery cell case, since high deep drawing characteristics are required, high strength ferritic stainless steel has a problem of relatively low workability.

### DISCLOSURE

### Technical Problem

Therefore, it is an aspect of the disclosure to provide a ferritic stainless steel that can improve heat dissipation and workability by improving the thermal conductivity through the alloy composition control and Al plating of ferritic stainless steel.

In addition, it is another aspect of the disclosure to provide a manufacturing method of a ferritic stainless steel that can improve the workability by controlling the alloy composition of the ferritic stainless steel and controlling a slab reheating temperature, a reduction ratio and a finishing delivery temperature of finishing rolling during hot rolling.

### Technical Solution

In accordance with one aspect of the disclosure, a ferritic stainless steel with improved heat dissipation and workability, includes, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities, and the ferritic stainless steel is plated with aluminum (Al) having a thickness of 5 to 50 μm.

In addition, according to an embodiment of the disclosure, the ferritic stainless steel may be characterized in that the thermal conductivity is 40 W/m·K or more.

In addition, according to an embodiment of the disclosure, the ferritic stainless steel may be characterized in that the R-bar is 2.0 or more.

In accordance with one aspect of the disclosure, a manufacturing method of a ferritic stainless steel with improved heat dissipation and workability, includes: manufacturing a stainless steel comprising, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities; reheating the stainless steel; rough rolling the stainless steel a plurality of times; finishing rolling the stainless steel; and cold rolling the stainless steel and plating aluminum (Al), and, in the plating step, the plating thickness is characterized in that 5 to 50 μm.

In addition, according to an embodiment of the disclosure, a temperature of the reheating step may be characterized in that 1100 to 1250° C.

In addition, according to an embodiment of the disclosure, a total reduction ratio of the last two passes of the rough rolling of the rough rolling step may be characterized in that 50% or more.

In addition, according to an embodiment of the disclosure, a finishing delivery temperature (FDT) of the finishing rolling of the finishing rolling step may be characterized in that 700 to 900° C.

### Advantageous Effects

Embodiments of the disclosure can improve the heat dissipation of ferritic stainless steel by introducing Al plating to the ferritic stainless steel to improve the thermal conductivity.

In addition, since corrosion resistance can be secured by Al plating, workability of ferritic stainless steel can be improved by reducing chromium (Cr) content and controlling hot rolling conditions.

In addition, when the ferritic stainless steel according to exemplary embodiments of the present invention is used in the end part of an exhaust system, for example, in a muffler-related material for an automotive exhaust system, a member of the automotive exhaust system, which ensures excellent corrosion resistance, without an increase in production cost in regions such as China, which uses conventional high sulfur fuel, may be manufactured.

### DESCRIPTION OF DRAWINGS

FIG. 1 is a view illustrating a change in thermal conductivity according to the Al plating thickness of ferritic stainless steel according to an embodiment of the disclosure.

FIG. 2 is a view illustrating a hot rolled structure when a finish delivery temperature (FDT) of hot rolling finishing rolling according to an embodiment of the disclosure is 820° C.

FIG. 3 is a view illustrating a hot rolled structure when a finishing delivery temperature (FDT) of hot rolling finishing rolling according to a comparative example is 930° C.

### BEST MODES OF THE INVENTION

A ferritic stainless steel with improved heat dissipation and workability according to an embodiment of the disclosure, includes, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities, and the ferritic stainless steel is plated with aluminum (Al) having a thickness of 5 to 50 μm.

### MODES OF THE INVENTION

Hereinafter, exemplary embodiments of the present invention will be described in detail with reference to accompanying drawings. The following examples are provided to fully deliver the spirit of the present invention to those of ordinary skill in the art. The present invention may be specified in different forms without limitation to examples, which will not be described herein. To clarify the present invention, illustration of parts that are not associated with the explanation will be omitted, and to help in understanding, the sizes of components will be slightly exaggerated.

According to one embodiment of the disclosure, a ferritic stainless steel includes, in weight %, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60% and the remainder of iron (Fe) and other inevitable impurities.

Hereinafter, the reason for the numerical limitation of the content of the alloying component in the embodiment of the disclosure will be described. In the following, the unit is weight % unless otherwise specified.

C: 0.0005˜0.02%

Carbon (C) is an element that improves the strength of the material, but when the content is excessive, impurities increase, the elongation and work hardening index (n value) fall, and the Ductile to Brittle Transition Temperature (DBTT) rises and the impact characteristic is inferior, so the upper limit is limited to 0.02%. However, if the content is too low, it is difficult to obtain the desired sufficient strength, and the refining cost for producing a high purity product increases, so the lower limit may be limited to 0.0005%.

N: 0.005˜0.02%

Nitrogen (N) is an element that precipitates austenite during hot rolling to promote recrystallization, but when the content is excessive, impurities increase, the elongation and work hardening index (n value) fall, and the Ductile to Brittle Transition Temperature (DBTT) rises and the impact characteristic is inferior, so the upper limit is limited to 0.02%. However, if the content is too low, the crystallization of TiN is lowered and the equiaxed crystallization rate of slab is lowered, so the lower limit may be limited to 0.0005%.

Cr: 10.0-17.0%

Chromium (Cr) is the most important element to ensure the corrosion resistance and oxidation resistance of stainless steel, in the disclosure is added more than 10%. However, when the content is excessive, the R-bar value indicating the elongation and deep drawing property is decreased, and hot-rolling sticking defects may occur, so the upper limit may be limited to 17.0%.

Ti: 0.02%-0.3%

Titanium (Ti) preferentially binds to carbon (C) and nitrogen (N) to fix carbon (C) and nitrogen (N) to reduce the amount of solid solution C and solid solution N in stainless steel, and is effective element in improving corrosion resistance of steel. However, if the content is excessive, the nozzle is clogged during slab manufacture by continuous casting due to the increase of Ti-based oxide, and workability is reduced, so the upper limit is limited to 0.3%. However, when the content is too low, the cost of ultra-low refining of impurities is high, and Nb is combined with C and N to precipitate, and the high temperature strength effect due to Nb solid solution is reduced, so the lower limit may be limited to 0.02%.

Nb: 0.1%˜0.6%

Niobium (Nb) is an element that preferentially combines with carbon (C) and nitrogen (N), which are invasive elements, to form a precipitate that suppresses a decrease in corrosion resistance. However, when the content is excessive, the Nb-based precipitates and the solid solution amount excessively increase, the elongation and impact characteristics deteriorate, and the raw material cost increases, so the upper limit is limited to 0.6%. However, when the content is too low, there is a problem that the high temperature strength of the material falls because there is little Nb dissolved in the material, the lower limit may be limited to 0.1%.

Since aluminum (Al) plating, which will be described later, may ensure corrosion resistance of the steel, the workability of the material may be secured by adjusting the component to reduce the content of chromium (Cr) compared to conventional ferritic stainless steel.

In addition, in order to secure the workability of the ferritic stainless steel of the disclosure, it is necessary to control the hot rolling process as well as the component control.

The hot rolling process may include a reheating step, a hot rough rolling step and a hot finishing rolling step.

In order to secure sufficient workability of the final cold rolled material, in the disclosed embodiment, the reheating temperature of the slab before hot rolling may be maintained at 1250° C. or less to prevent coarsening of internal grains.

However, in order to re-decompose coarse precipitates generated during slab casting, the hot rolled reheating temperature of the slab before hot rolling may be set to 1100° C. or higher.

Then, in the hot rolling step, the rough rolling load distribution may be moved to the rear end where the strip mass flow temperature is lower than the front end. That is, by reducing the reduction ratio to 50% or more during the last two times of hot rough rolling, the nucleation site can be induced as much as possible to promote recrystallization of the tissue.

Thereafter, after performing the rough rolling on the stainless steel, by controlling the time before performing the finishing rolling to 120 seconds or less, coarsening of the crystal grains may be prevented.

Subsequently, finishing rolling is performed. In the manufacturing method of ferritic stainless steel according to an embodiment of the disclosure, the finishing delivery temperature (FDT) of the finishing rolling, which is designed to be higher than the recrystallization temperature, may be controlled to 700° C. to 900° C. so that recrystallization may occur actively during annealing.

When the finishing delivery temperature (FDT) of the finishing rolling is less than 700° C., there is a problem in that it is difficult to secure a strip mass flow. When the finishing delivery temperature of the finishing rolling is more than 900° C., there is a problem that workability is deteriorated because the R-bar value of the final material decreases because strain energy cannot be properly accumulated in the slab.

For hot rolled steel sheet manufactured in this way, a heat dissipation may be improved by performing aluminum (Al) plating of 5 to 50 μm thickness on the cold rolled steel sheet subjected to the usual hot rolled annealing, cold rolling and cold rolled annealing.

Next, the aluminum plating condition and process of the disclosure are demonstrated. The process of plating aluminum on the ferritic stainless steel surface of the disclosure consists of a pretreatment step, a preheating and heating step, and an aluminum plating step of the base steel sheet. The pretreatment, preheating and heating step, and plating step may use a conventional aluminum hot dip plating process.

The pretreatment step of the base steel sheet may include pickling or washing to remove scale or dust remaining on the surface of the steel sheet.

Subsequently, after preheating and heating, the steel sheet is immersed in an aluminum plating bath to aluminum plating.

The aluminum plating bath may include, in % by weight, silicon (Si): 5 to 15%, the remainder of aluminum (Al), and inevitable impurities.

Among the components in the aluminum plating bath, silicon (Si) suppresses the growth of Fe—Al-based intermetallic compounds formed at the interface between the base steel sheet and the plating layer to improve the heat resistance of the plating steel sheet, and is an element that improves the plating quality by improving the fluidity of the plating liquid in the plating bath.

On the other hand, when the content of Si is excessive, there is a problem that Si segregation in the plating layer is severe, a cooling process is required after high output plating in order to obtain a fine structure, and the color of the plating steel sheet becomes dark.

On the other hand, the aluminum plating may be carried out under ordinary plating conditions. For example, the aluminum plating bath may have a temperature of 630 to 680° C. When the bath temperature is less than 630° C., there is a problem that the fluidity of the plating liquid in the plating bath may be lowered. On the other hand, when the bath temperature exceeds 680° C., there is a problem that a dross increases rapidly in the plating bath due to the precipitation of Fe from various metal structures in the plating bath.

After the plating is completed, the plating thickness may be adjusted by gas wiping the ferritic stainless steel sheet on which the aluminum plating layer is formed. The gas wiping is for adjusting the plating deposition amount, and the method is not particularly limited.

Aluminum plating thickness according to an embodiment of the disclosure may be 5 to 50 μm.

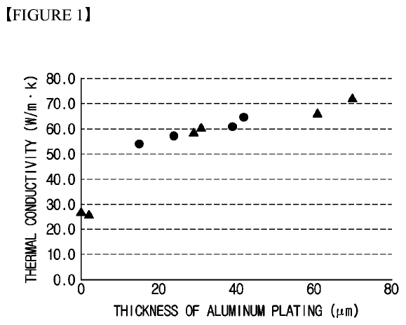

Referring to Table 2 and FIG. 1, when the plating thickness is less than 5 μm, sufficient thickness for heat transfer is not obtained, and thermal conductivity is not improved (see Comparative Examples 1 and 2).

When the plating thickness is more than 50 μm, there is a problem that the plating film is peeled off during deep drawing (see Comparative Examples 3 and 4).

Thereafter, after performing cooling and shape correction, the coil is wound in a tension reel to obtain a ferritic stainless steel cold rolled steel sheet plated with final aluminum.

When measuring the thermal conductivity of the material manufactured by the above method, it is possible to obtain a value of 40 W/m·K or more (see FIG. 1).

In addition, by calculating the R-bar (=(R0+R90+2*R45)/4) by measuring the R value in the 0/45/90 degrees with respect to the rolling direction, a value of 2.0 or more may be obtained.

Here, R0 is an R value in the 0 degree direction, R45 is an R value in the 45 degree direction, and R90 is an R value in the 90 degree direction. The R value is the width strain/thickness strain.

The R value is expressed as width strain/thickness strain (εw/εt), the higher the R value, the greater the degree of freedom in forming. Generally, in order to have a high R value, the width strain must be greater than the thickness strain.

The R values are calculated using the following equation (3) after giving 15% deformation in the rolling direction (R0), the 45° direction (R45) with respect to the rolling direction, the 90° direction (R90) with respect to the rolling direction, respectively.

R=ln(W0/W)/ln(t0/t) <equation (3)>

At this time, W0 is a sheet width before tensioning, W is a sheet width after tensioning, t0 is a sheet thickness before tensioning, and t is a sheet thickness after tensioning.

The R values increase in formability as their size increases, and the larger R values are advantageous.

Hereinafter, the disclosure will be described in more detail with reference to Examples and Comparative Examples.

### Examples 1-4

Slabs were prepared according to the compositions of the inventive steels 1 to 4, respectively, and then reheated at a temperature of 1,200° C. in a heating furnace. Then, hot rough rolling was performed, and the final two rough rollings were performed with a total reduction ratio of 50%. After rough rolling, the inventive steels were held for 60 seconds before finishing rolling. Thereafter, finishing rolling was performed at a finishing delivery temperature (FDT) of the finishing rolling of 850° C. and 5 mm thick hot rolled coil was manufactured. In addition, cold rolling was performed and aluminum was plated to produce the final product.

### Comparative Examples 1 to 6

After the slabs were manufactured according to the compositions of Comparative Steels 1 to 6, the aluminum was plated through conventional hot rolling processes and cold rolling processes.

The compositions of the inventive and comparative steels are shown in Table 1 below.

TABLE 1

| | | | | | | A1 plating |
|---|---|---|---|---|---|---|
| | | | | | | thickness |
| | C | N | Cr | Ti | Nb | (μm) |
| Example 1 | 0.005 | 0.008 | 11.6 | 0.17 | 0.21 | 15 |
| Example 2 | 0.009 | 0.012 | 13.2 | 0.12 | 0.32 | 24 |
| Example 3 | 0.012 | 0.009 | 14.5 | 0.28 | 0.40 | 39 |
| Example 4 | 0.015 | 0.011 | 15.8 | 0.23 | 0.51 | 42 |
| Comparative | 0.005 | 0.008 | 11.6 | 0.17 | 0.21 | — |
| Examples 1 | | | | | | |
| Comparative | 0.009 | 0.012 | 13.2 | 0.12 | 0.32 | 2 |
| Examples 2 | | | | | | |
| Comparative | 0.012 | 0.009 | 14.5 | 0.28 | 0.40 | 61 |
| Examples 3 | | | | | | |
| Comparative | 0.015 | 0.011 | 15.8 | 0.23 | 0.51 | 70 |
| Examples 4 | | | | | | |
| Comparative | 0.006 | 0.008 | 17.9 | 0.17 | 0.45 | 29 |
| Examples 5 | | | | | | |
| Comparative | 0.009 | 0.009 | 19.2 | 0.16 | 0.52 | 31 |
| Examples 6 | | | | | | |

Referring to Table 1, Comparative steels 1 to 4 satisfy the composition of ferritic stainless steel according to an embodiment of the disclosure. On the other hand, Comparative steels 1 and 2 have a thin Al plating thickness, Comparative steels 3 and 4 have a thick Al plating thickness, and Comparative steels 5 and 6 are out of chromium (Cr) content.

Accordingly, whether the plating of the inventive steels and the comparative steels are peeled off and the physical properties are shown in Table 2 below.

TABLE 2

| | | thermal conductivity | |
|---|---|---|---|
| | peeling off | (W/m · K) | R-bar |
| Example 1 | | 54.2 | 2.24 |
| Example 2 | | 57.3 | 2.29 |
| Example 3 | | 60.9 | 2.18 |
| Example 4 | | 64.7 | 2.15 |
| Comparative Examples 1 | | 26.5 | 2.21 |
| Comparative Examples 2 | | 25.9 | 2.31 |
| Comparative Examples 3 | Occur | 66.1 | 2.11 |
| Comparative Examples 4 | Occur | 72.0 | 2.17 |
| Comparative Examples 5 | | 58.4 | 1.72 |
| Comparative Examples 6 | | 60.5 | 1.84 |

Referring to Table 2 and FIG. 1, when the composition of the ferritic stainless steel satisfies the composition according to an embodiment of the disclosure and Al plating thickness is 5-50 μm, no peeling phenomenon occurs during deep drawing process, and thermal conductivity is 40 W/m·K or more, accordingly, it can be seen that the heat dissipation for releasing the generated heat to the outside is improved.

In addition, referring to Table 2, in Comparative Example 5 and Comparative Example 6, it can be seen that the chromium (Cr) content exceeded 17% and the R-bar value, which is an indicator of workability, was found to be less than 2.0.

In addition, referring to Table 2 above, For Examples 1-4 where the composition of the ferritic stainless steel satisfies the composition according to an embodiment of the disclosure, the reheating temperature of the hot rolled slab is 1100 to 1250° C., the total reduction ratio of the last two passes of rough rolling is 50% or more and the finishing delivery temperature (FDT) of the finishing rolling is 700 to 900° C., the R-bar is 2.0 or more.

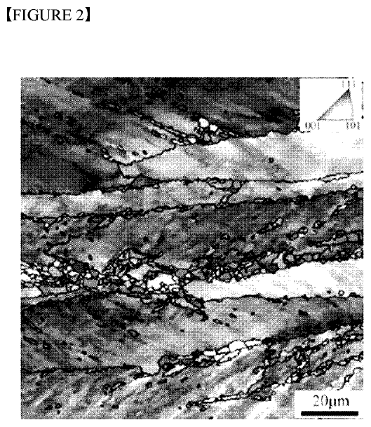

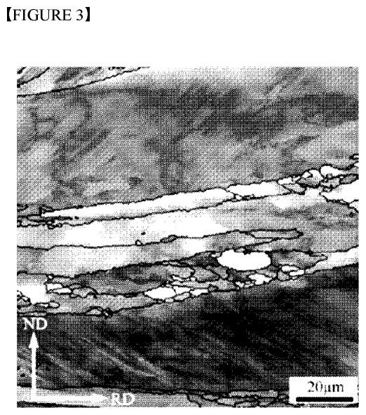

Referring to FIGS. 2 and 3, in an embodiment of the disclosure, since the finishing delivery temperature (FDT) of the finishing rolling is 820° C., which is lower than that of the comparative example of 930° C., it can be confirmed that the recrystallization indicated by the dark portion is actively generated due to sufficient accumulation of deformation energy in the slab and, as a result, it can be seen that workability is improved.

As described above, while the disclosure has been described with reference to embodiments of the disclosure, the disclosure is not limited thereto, and it will be understood by those of ordinary skill in the art that various modifications and alternations can be made without departing from the concept and scope of the accompanying claims.

### INDUSTRIAL APPLICABILITY

Ferritic stainless steel according to an embodiment of the disclosure is improved heat dissipation and workability and is applied to various applications such as electric vehicle battery material.

1. A ferritic stainless steel with improved heat dissipation and workability, comprising, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities,
wherein the ferritic stainless steel is plated with aluminum (Al) having a thickness of 5 to 50 μm.

2. The ferritic stainless steel according to claim 1, wherein the ferritic stainless steel is characterized in that the thermal conductivity is 40 W/m·K or more.

3. The ferritic stainless steel according to claim 1, wherein the ferritic stainless steel is characterized in that the R-bar is 2.0 or more.

4. A manufacturing method of a ferritic stainless steel with improved heat dissipation and workability, comprising:
manufacturing a stainless steel comprising, in % by weight, carbon (C): 0.0005 to 0.02%, nitrogen (N): 0.005 to 0.02%, chromium (Cr): 10.0 to 17.0%, titanium (Ti): 0.02 to 0.30%, niobium (Nb): 0.10 to 0.60%, and the remainder of iron (Fe) and other inevitable impurities;
reheating the stainless steel;
rough rolling the stainless steel a plurality of times;
finishing rolling the stainless steel; and
cold rolling the stainless steel and plating aluminum (Al),
wherein, in the plating step, the plating thickness is characterized in that 5 to 50 μm.

5. The manufacturing method according to claim 4, wherein a temperature of the reheating step is characterized in that 1100 to 1250° C.

6. The manufacturing method according to claim 5, wherein a total reduction ratio of the last two passes of the rough rolling of the rough rolling step is characterized in that 50% or more.

7. The manufacturing method according to claim 6, wherein a finishing delivery temperature (FDT) of finishing rolling of the finishing rolling step is characterized in that 700 to 900° C.
